(19) United States
(12) Patent Application Publication
(10) Pub. No.: US 2008/0250504 A1
(43) Pub. Date: Oct. 9, 2008

(54) DIGITAL RIGHTS MANAGEMENT METHOD AND APPARATUS

(75) Inventors: Won-seok Kwon, Suwon-si (KR); Hyoung-shick Kim, Suwon-si (KR); Dong-shin Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/870,643

(22) Filed: Oct. 11, 2007

Related U.S. Application Data
(60) Provisional application No. 60/900,346, filed on Feb. 9, 2007.

(30) Foreign Application Priority Data
May 4, 2007 (KR) 10-2007-0043637

(51) Int. Cl. G06F 21/00

(52) U.S. Cl. 726/26

(57) ABSTRACT

A digital rights management (DRM) method and apparatus are provided. The DRM method includes transmitting a rights object request message; receiving a rights object response message based on a Universal Plug and Play (UPnP) contents directory service; and acquiring a rights object using the rights object response message. Another DRM method includes receiving a rights object request message; and transmitting a rights object response message based on a Universal Plug and Play (UPnP) contents directory service. The DRM apparatus includes a transmitting unit which transmits a rights object request message to a media server of a DRM domain; a receiving unit which receives a rights object response message based on a Universal Plug and Play (UPnP) contents directory service from the media server; and a playback unit which plays back a contents object on a basis of a rights object acquired using the rights object response message.

### CROSS-REFERENCE TO RELATED APPLICATION

This application claims priority from U.S. Provisional Application No. 60/900,346 filed on Feb. 9, 2007 in the United States Patent and Trademark Office and Korean Patent Application No. 10-2007-0043637 filed on May 4, 2007 in the Korean Intellectual Property Office, the disclosures of which are incorporated herein by reference in its entirety.

### BACKGROUND OF THE INVENTION

1. Field of the Invention

Methods and apparatuses consistent with the present invention relate to digital rights management, and in particular, to a digital rights management method and apparatus that can effectively manage a rights object.

2. Description of the Related Art

In recent years, digital rights management (hereinafter, referred to as “DRM”) has been actively studied, and commercial services using DRM have been introduced or are being introduced. DRM is a technical concept that protects digital contents from unauthorized copying and distribution.

Efforts to protect digital contents have been made, but these efforts have emphasized preventing an unauthorized access to the digital contents. For example, an access to the digital contents is permitted for only a user who pays for the digital contents, while a user who does not pay for the digital contents cannot access the digital contents. However, due to the characteristics of digital data, the digital contents can be easily reused, processed, copied, and distributed. Accordingly, if a user who pays for the digital contents accesses the digital contents, and copies and distributes the digital contents without permission, a user who does not pay for the digital contents can use the digital contents.

In order to address this problem, the digital contents are encrypted and then distributed according to the DRM. Then, a user should have a license, called a rights object (RO), in order to use the encrypted digital contents.

The rights object protects the digital contents, and thus there is a need for a technology that can effectively manage the rights object.

### SUMMARY OF THE INVENTION

An object of the present invention is to allow devices to share a rights object.

Objects of the invention are not limited to those mentioned above, and other objects of the invention will be apparently understood by those skilled in the art through the following description.

According to an aspect of the present invention, there is provided a digital rights management (DRM) method, the DRM method including transmitting a rights object request message to a media server of a DRM domain, receiving a rights object response message based on a Universal Plug aNd Play (UPnP) contents directory service (CDS) from the media server, and acquiring a rights object using the rights object response message.

According to another aspect of the present invention, there is provided a DRM method, DRM method including receiving a rights object request message from a media renderer of a DRM domain, and transmitting a rights object response message based on a UPnP contents directory service to the media renderer.

According to still another aspect of the present invention, there is provided a DRM apparatus, the DRM apparatus including a transmitting unit which transmits a rights object request message to a media server of a DRM domain, a receiving unit which receives a rights object response message based on a UPnP contents directory service from the media server, and a playback unit which plays back a contents object on the basis of a rights object acquired using the rights object response message.

According to yet still another aspect of the present invention, there is provided a DRM apparatus, the DRM apparatus including a receiving unit which receives a rights object request message from a media renderer of a DRM domain, and a transmitting unit which transmits a rights object response message based on a UPnP contents directory service to the media renderer.

According to yet still another aspect of the present invention, there is provided a DRM method, the DRM method including, when a media server exists in a DRM domain, acquiring a rights object from the media server, and when the media server does not exist in the DRM domain, acquiring a rights object from a rights object issuing server. The acquiring of the rights object from the media server may include transmitting a rights object request message to the media server, receiving a rights object response message based on a UPnP contents directory service from the media server, and acquiring a rights object using the rights object response message.

### BRIEF DESCRIPTION OF THE DRAWINGS

The above and other aspects of the present invention will become more apparent by describing in detail exemplary embodiments thereof with reference to the attached drawings in which:

FIG. 1 is a diagram showing a digital rights management (DRM) system according to an exemplary embodiment of the present invention;

FIG. 2 is a flowchart illustrating a process, through which a media renderer subscribes to a DRM domain, according to an exemplary embodiment of the present invention;

FIG. 3 is a flowchart illustrating a process, through which a media renderer acquires a domain rights object, according to an exemplary embodiment of the present invention;

FIG. 4 is a flowchart illustrating a process, through which a media renderer acquires a domain rights object from a media server, according to an exemplary embodiment of the present invention;

FIGS. 5A to 5I are diagrams showing actions based on UPnP CDS according to an exemplary embodiment of the present invention;

FIG. 6 is a block diagram showing a media renderer according to an exemplary embodiment of the present invention; and

FIG. 7 is a block diagram showing a media server according to an exemplary embodiment of the present invention.

### DETAILED DESCRIPTION OF EXEMPLARY EMBODIMENTS OF THE PRESENT INVENTION

Exemplary embodiments of the present invention may be understood more readily by reference to the following detailed description of exemplary embodiments and the accompanying drawings. The present inventive concept may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention will only be defined by the appended claims. Like reference numerals refer to like elements throughout the specification.

Hereinafter, an exemplary embodiment of the present invention will be described in detail with reference to the accompanying drawings.

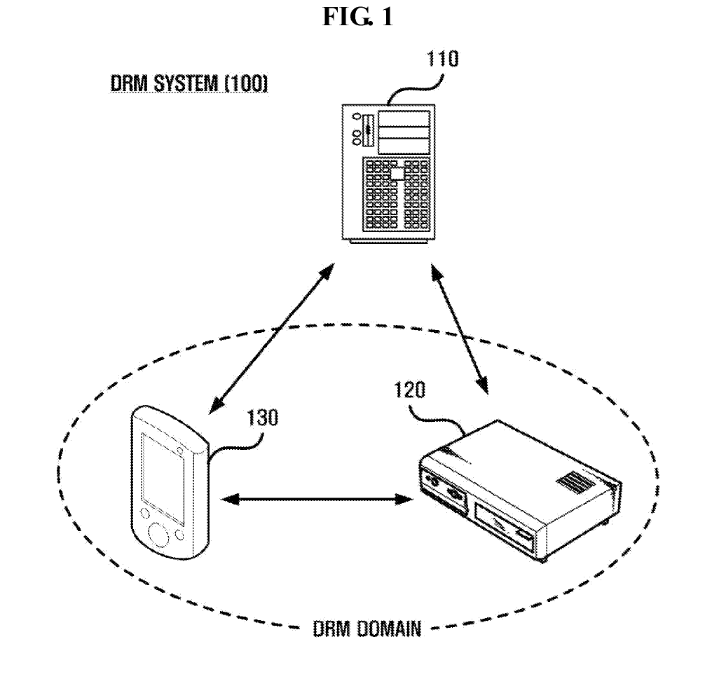

FIG. 1 is a diagram showing a digital rights management (hereinafter, referred to as “DRM”) system 100 according to an exemplary embodiment of the present invention. The DRM system 100 includes a rights object issuing server 110 (also referred to as “Rights Issuer (RI)”), a media server 120, and a media renderer 130. Although a case where each of the rights object issuing server 110, the media server 120, and the media renderer 130 is provided individually is shown in FIG. 1, each of the components may be plurally provided.

The media server 120 includes a storage medium, such as a hard disk or a flash memory, to store a contents object or a rights object (RO) and to provide a contents object or a rights object stored therein to the media renderer 130. Examples of the media server 120 may include, but are not limited to, a Personal Video Recorder (PVR), a Personal Computer (PC), and the like.

The media renderer 130 receives a rights object from the media server 120, and plays back a contents object using the received rights object. The contents object to be played back may be acquired from the media server 120 or may be acquired through other devices or networks. The media renderer 130 can acquire the rights object through other devices or networks. Examples of the media renderer 130 may include, but are not limited to, a digital television (TV), a Portable Multimedia Player (PMP), a cellular phone, a personal digital assistant (PDA), an MP3 player, and the like.

The rights object issuing server 110 issues the rights object, and provides the rights object to the device (for example, the media server 120 or the media renderer 130) of a user who pays for the corresponding contents.

The contents object is encrypted digital contents. The digital contents may include various types of contents, such as videos, music, images, games, documents, and the like.

The rights object is a kind of license that gives permission of the contents object. The rights object includes a content encryption key (CEK), permission information, constraint information, and a contents identifier (ID) of the contents object that can be decoded by the contents encryption key.

The contents encryption key is used to play back a contents object and has a binary value. The binary value may be predetermined. For example, the contents encryption key can be used to decode the contents object and to acquire the original digital contents.

The permission information denotes a playback type of a contents object and a copy type of a rights object.

Examples of the playback type may include, but are not limited to, “Play”, “Display”, “Execute”, “Print”, and the like. Here, “Play” denotes rights to express a contents object in an audio or video format. For example, when the contents object is a moving picture or music, “Play” can be set as permission information of a rights object to be used to play back the corresponding contents object. Further, “Display” denotes rights to express a contents object on a visual apparatus, and “Print” denotes rights to generate a hard copy of a contents object. For example, when the contents object is a still picture, at least one of “Display” and “Print” can be set as permission information of a rights object to be used to play back the corresponding contents object. In addition, “Execute” denotes rights to use a contents object, such as a game or another application program. For example, when the contents object is a Java game, “Execute” can be set as permission information to be used to play back the corresponding contents object.

Examples of the copy type may include, but are not limited to, “Copy” and “Move”. “Copy” and “Move” denote rights to store a rights object, which is stored in a device, in another device. In case of “Move”, if a rights object is stored in another device, the rights object stored in the existing device is inactivated. In case of “Copy”, however, even if the rights object is stored in another device, the rights object stored in the existing device remains activated. Here, the inactivation may mean the deletion of the rights object.

The constraint information denotes constraints on allowing a contents object to be played back, and one or more kinds of constraint information may be set for the permission information. Examples of the constraint information may include, but are not limited to, a count constraint, a date or time constraint, an interval constraint, and an accumulated time constraint.

The descriptions of the contents object and the rights object are just illustrative, and the present invention is not limited thereto.

Returning to FIG. 1, the media server 120 and the media renderer 130 construct a DRM domain. The DRM domain is a collection of devices that can share a rights object. For example, “Move” or “Copy” of the rights objects is permitted between the devices in the same DRM domain. Hereinafter, a “domain rights object” denotes a rights object that can be shared between the devices in a DRM domain.

The rights object issuing server 110 manages the DRM domain. For example, the rights object issuing server 110 generates the DRM domain and controls subscription or secession of a device with respect to the DRM domain. According to an exemplary embodiment of the present invention, DRM domain management can be performed based on the Open Mobile Alliance (OMA) DRM standard. However, since a specific process for the DRM domain management can be implemented in various ways according to exemplary embodiments, the present invention is not limited to a specific process of DRM domain management or a specific process of the rights object issuing server 110. Although the detailed description of the DRM domain management will be omitted herein, for better understanding of the present invention, a process, through which the media renderer 130 subscribes to the DRM domain, will be described.

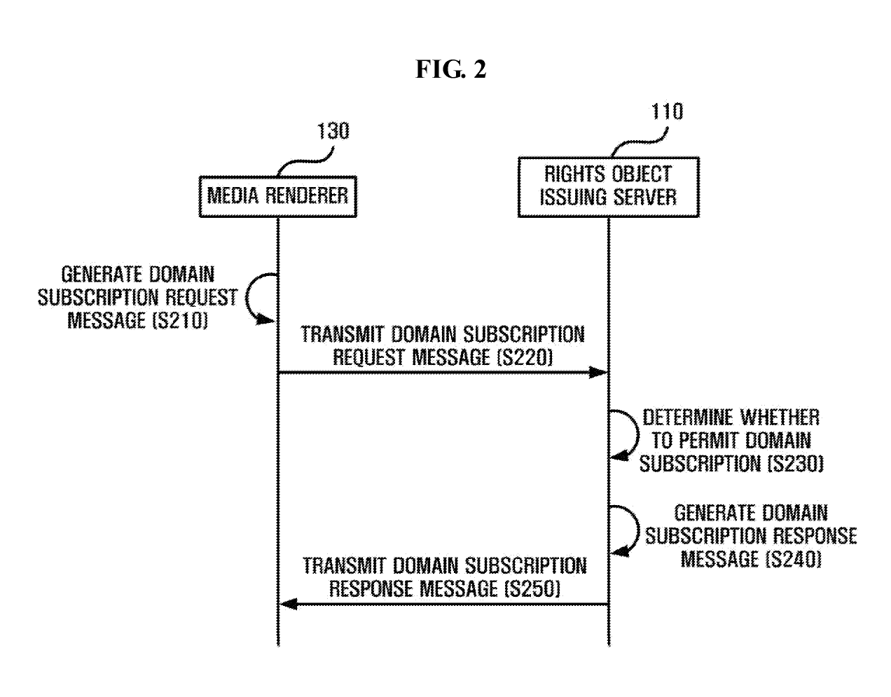

FIG. 2 is a flowchart illustrating a process, through which the media renderer 130 subscribes to the DRM domain, according to an exemplary embodiment of the present invention.

In order to subscribe to the DRM domain, the media renderer 130 generates a domain subscription request message (operation S210), and transmits the generated domain subscription request message to the rights object issuing server 110 (operation S220). The domain subscription request message may include a device ID of the media renderer 130 and a domain ID of the DRM domain, to which the media renderer 130 subscribes. The domain ID denotes information for identifying the DRM domain, and is allocated to the DRM domain by the rights object issuing server 110 when the DRM domain is generated. The media renderer 130 can acquire the domain ID in advance through a user's input or an inquiry on a device which has already subscribed to the DRM domain.

The rights object issuing server 110 that receives the domain subscription request message determines whether or not to permit the subscription of the media renderer 130 to the DRM domain (operation S230). For example, if the number of devices that can subscribe to the DRM domain is limited to a threshold number, the rights object issuing server 110 determines whether or not the number of devices that has already subscribed to the DRM domain is smaller than the threshold number. If the number of devices that has already subscribed to the DRM domain is smaller than the threshold number, the rights object issuing server 110 permits the subscription of the media renderer 130. However, if the number of devices that subscribed to the DRM domain already is not smaller than the threshold number (that is, equal to the threshold number), the rights object issuing server 110 rejects the subscription of the media renderer 130. A method that is used when the media server 110 determines whether or not to permit the subscription of the media renderer 130 can be implemented in various ways according to exemplary embodiments, and accordingly the present invention is not limited to ways illustrated by the exemplary embodiments.

The rights object issuing server 110 generates a domain subscription response message (operation S240), and transmits the generated domain subscription response message to the media renderer 130 (operation S250). The domain subscription response message may include information on whether or not to permit the subscription. According to an exemplary embodiment of the present invention, when the domain subscription response message is a message purporting that the subscription to the DRM domain is permitted, the domain subscription response message includes a domain key. When the subscription of the DRM domain is successfully performed, the media renderer 130 acquires the domain key through the domain subscription response message. Accordingly, the devices that subscribe to the DRM domain retain the domain key that is provided by the rights object issuing server 110.

According to an exemplary embodiment of the present invention, the domain key allows the devices to share the domain rights object in the DRM domain. For example, the domain rights object or the contents encryption key in the domain rights object may be encrypted by the domain key. In this case, a device that does not retain the domain key can acquire the rights object but cannot use the rights object. On the other hand, a device that retains the domain key can decode an encrypted rights object or an encrypted contents encryption key using the domain key. Accordingly, the domain rights object can be prevented from being used by an external device. However, the present invention is not limited to such a domain rights object protection method.

According to another exemplary embodiment of the present invention, the domain key may protect a communication session between the devices in the DRM domain. For example, various messages or data that is transmitted between the devices in the DRM domain may be encrypted by the domain key. In this case, the devices that retain the domain key can request other devices for the domain rights object and response the request. However, a device that does not retain the domain key cannot successfully perform these operations. In addition, there can be various methods that protect the domain rights object using the domain key or information other than the domain key, and accordingly the present invention is not limited to a specific rights object protection method.

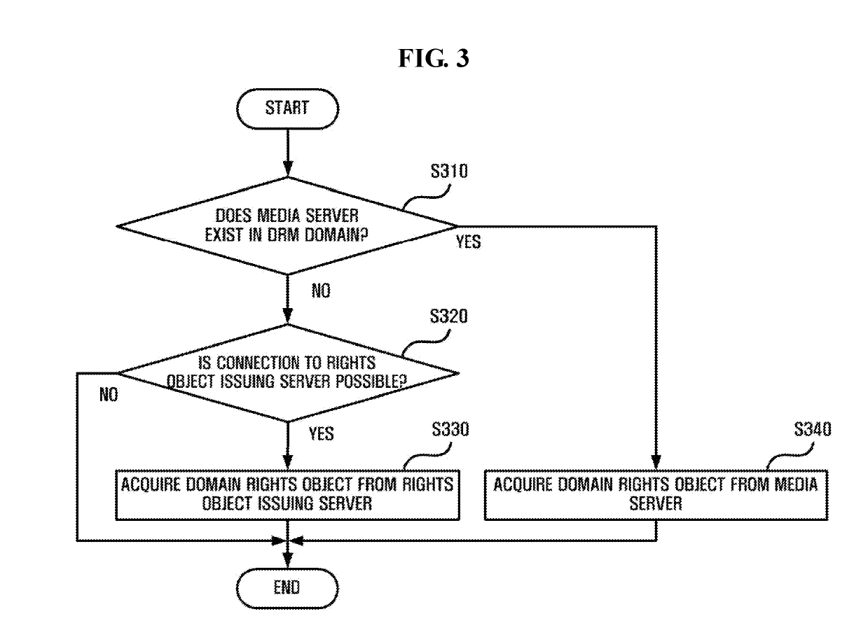

FIG. 3 is a flowchart illustrating a process, through which the media renderer 130 acquires the rights object, according to an exemplary embodiment of the present invention.

The media renderer 130 confirms whether or not the media server 120 exists in the DRM domain (operation S310). According to an exemplary embodiment of the present invention, the media renderer 130 and the media server 120 are Universal Plug and Play Audio Video (UPnP AV) compatible devices. The media renderer 130 may include a UPnP control point function. In this case, information on whether the media server 120 exists in the DRM domain can be informed through UPnP-based discovery or advertising.

If it is determined that the media server 120 does not exist in the DRM domain, the media renderer 130 determines whether or not a connection to the rights object issuing server 110 is possible (operation S320). The possibility of the connection to the rights object issuing server 110 can be confirmed according to whether or not a connection to an external network (for example, Internet), to which the rights object issuing server 110 is connected, is possible.

If it is determined that the connection to the rights object issuing server 110 is possible, the media renderer 130 can acquire the domain rights object from the rights object issuing server 110 (operation S330). At operation S330, the media renderer 130 requests the rights object issuing server 110 for the domain rights object, and the rights object issuing server 110 provides the domain rights object requested by the media renderer 130. When requesting the domain rights object, using the Domain ID, the media renderer 130 may inform the rights object issuing server 110 of what DRM domain needs the rights object to use. The process, through which the media renderer 130 acquires the rights object from the rights object issuing server 110, is not intended to limit the exemplary embodiments of the present invention.

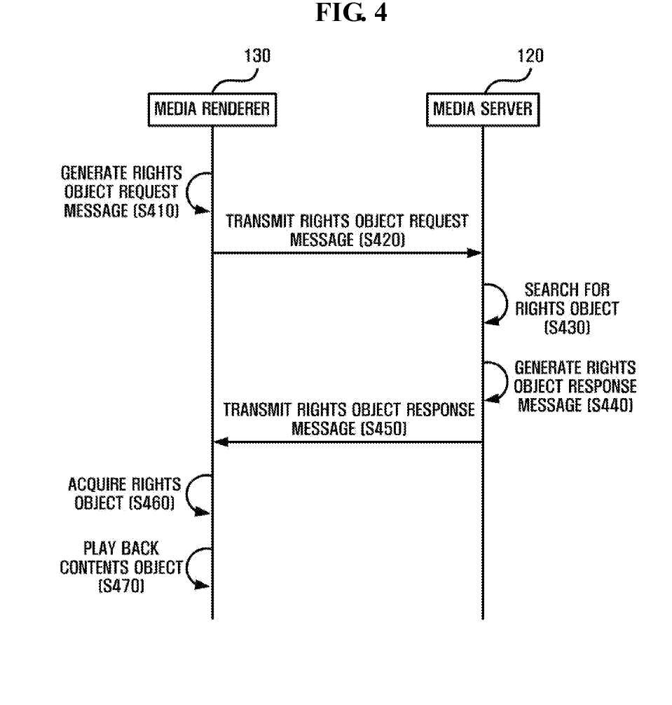

If it is determined in operation S310 that the media server 120 exists, the media renderer 130 acquires the domain rights object from the media server 120 (operation S340). A more detailed description will be given below of operation S340 with reference to FIG. 4.

FIG. 4 is a flowchart illustrating a process, through which the media renderer 130 acquires the domain rights object from the media server 120, according to an exemplary embodiment of the present invention. In this exemplary embodiment, it is assumed that the media server 120 acquires the domain rights object from the rights object issuing server 110 in advance, and the media renderer 130 does not retain the required domain rights object.

In order to play back the contents object, the media renderer 130 generates a rights object request message (operation S410), and transmits the generated rights object request message to the media server 120 (operation S420). The rights object request message includes basic search information that is used for the media server 120 to search the rights object requested by the media renderer 130. For example, the rights object request message may include a rights object ID of the rights object requested by the media renderer 130. Further, the rights object request message may include a contents ID that the media renderer 130 plays back the contents object. The rights object ID and the contents ID are identifiers for identifying the rights object and the contents object in the DRM standard of the DRM domain. Examples of the DRM standard may include OMA (Open Mobile Alliance) DRM and the like.

Although a detailed description will be given below, according to an exemplary embodiment of the present invention, the rights object request message may include an object ID that is used to identify an object in the UPnP contents directory service (UPnP CDS) standard. In this case, the rights object is identified by the object ID in the rights object request message.

The media server 120 that receives the rights object request message searches for the rights object requested by the media renderer 130 (operation S430). If the rights object request message includes the rights object ID, the media server 120 can search for the rights object to be identified through the rights object ID. Further, if the rights object request message includes the contents ID, the media server 120 can search for the rights object having rights to play back the contents object to be identified by the contents ID. Since the rights object ID or the contents ID is recorded in a specific field of the rights object, the media server 120 can search for the rights object by confirming the field, in which the rights object ID or the contents ID is recorded, for every rights object stored therein. This is an example, and the present invention is not limited thereto. According to another exemplary embodiment of the present invention, the media server 120 manages metadata including a contents ID of a contents object, which can be played back using a rights object ID of a rights object stored therein or the rights object, together with the rights object. In this case, the media server 120 can search for the rights object using the metadata without confirming the specific field of the rights object.

If the rights object request message includes a UPnP CDS-based object ID, the media server 120 can search an object (that is, rights object) to be identified by the object ID.

As the search result of the rights object, if the rights object requested by the media renderer 130 is found, the media server 120 generates a rights object response message (operation S440), and transmits the generated rights object response message to the media renderer 130 (operation S450). According to an exemplary embodiment of the present invention, the rights object response message may include the found rights object. According to another exemplary embodiment of the present invention, the rights object response message may include a Uniform Resource Identifier (URI) of the found rights object. If the rights object requested by the media renderer 130 is not found, the media server 120 may generate a rights object response message including information purporting that no rights object exists, and may transmit the generated rights object response message to the media renderer 130.

The media renderer 130 that receives the rights object response message acquires the rights object using the rights object response message (operation S460). If the rights object response message includes a rights object, the media renderer 130 can directly acquire the rights object from the rights object response message. If the rights object response message includes the URI of the rights object, the media renderer 130 accesses the corresponding URI to acquire the rights object.

Subsequently, the media renderer 130 plays back the contents object using the acquired rights object (operation S470).

Though not described in the exemplary embodiment of FIG. 4, security of the domain rights object in the DRM domain is continuously maintained. For example, in FIG. 4, the domain rights object or the contents encryption key of the domain rights object may be encrypted by the domain key allocated from the rights object issuing server 110. Further, the media server 120 and the media renderer 130 may encode and decode the messages transmitted/received therebetween using the domain key. As described above, the rights object protection method can be implemented in various ways according to the exemplary embodiments of the present invention.

According to an exemplary embodiment of the present invention, the devices that form the DRM domain may be UPnP AVcompatible devices. The media renderer 130 may include a UPnP AV-based control point function. However, the present invention is not limited thereto. A device that performs a similar function as the control point is provided separately from the media renderer 130.

When the devices of the DRM domain follow the UPnP AV associated UPnP standards, in the exemplary embodiment of FIG. 4, the rights object request message and the rights object response message that are transmitted between the media renderer 130 and the media server 120 are based on the UPnP CDS. More specifically, in FIG. 4, the rights object request message transmitted at operation S420 and the rights object response message transmitted at operation S450 may be generated using a UPnP CDS-based action. Hereinafter, an exemplary embodiment in which a UPnP AV protocol is applied in order to allow the devices of the DRM domain to request and acquire the domain rights object therebetween will be described.

According to an exemplary embodiment of the present invention, in order to allow the media renderer 130 and the media server 120 to share the rights object in the DRM domain, a new UPnP CDS-based action may be defined. Hereinafter, the new action is referred to as “X_GetLicense”. Table 1 shows the arguments of the X_GetLicense action according to an exemplary embodiment of the present invention.

TABLE 1

| Argument | Direction | Status Variable |
|---|---|---|
| ID | IN | A_ARG_TYPE_ContentID or |
| | | A_ARG_TYPE_ROID |
| ID Type (IDType) | IN | A_ARG_TYPE_IDType |
| DRM Type | IN | A_ARG_TYPE_DRMType |
| (DRMType) | | |
| License | OUT | A_ARG_TYPE_ContentLicense |

In Table 1, the direction denotes to which of the request and response each argument belongs. The request is a concept that is included in the rights object request message, and the response is a concept that is included in the rights object response message. In Table 1, the direction “IN” denotes that the argument is included in the request, the direction “OUT” denotes that the argument is included in the response.

In Table 1, the argument “ID” denotes the contents ID or the rights object ID. The media renderer 130 that transmits the rights object request message allows the request using the X_GetLicense action to include a contents ID of a contents object to play back or a rights object ID of a rights object.

In Table 1, the argument “ID Type” denotes which of the contents ID and the rights object ID the argument “ID” represents. The argument “DRM Type” denotes a supportable DRM method. Accordingly, the media server 120 that receives the request using the X_GetLicense action can see through the argument “DRM Type” that the media renderer 130 requires the rights object based on the DRM standard to be identified.

In Table 1, the argument “License” denotes the rights object or the URI of the rights object.

In Table 1, the status variable denotes a variable associated with each argument, and may be represented by any format or value as long as it is suitable for the UPnP CDS standard.

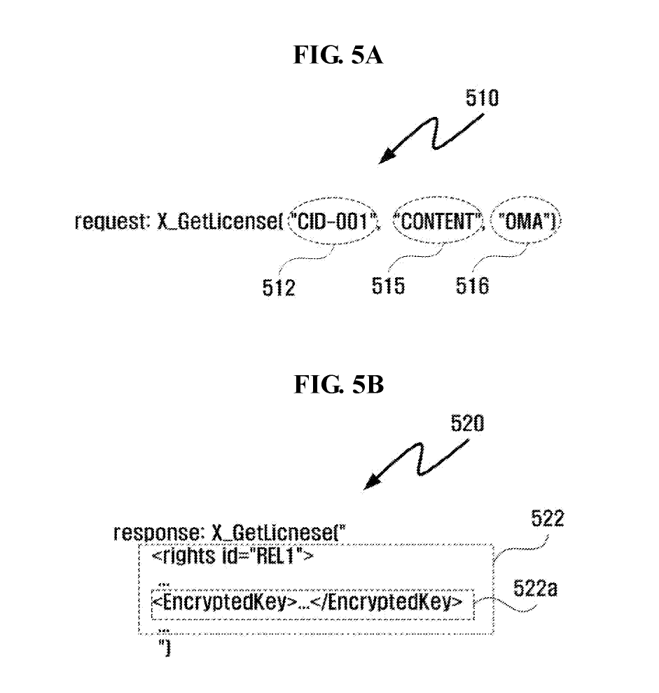

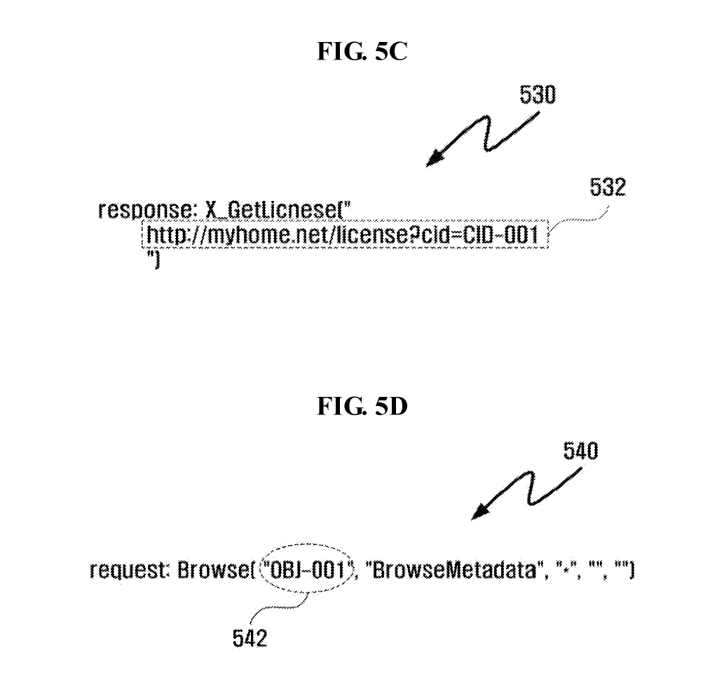

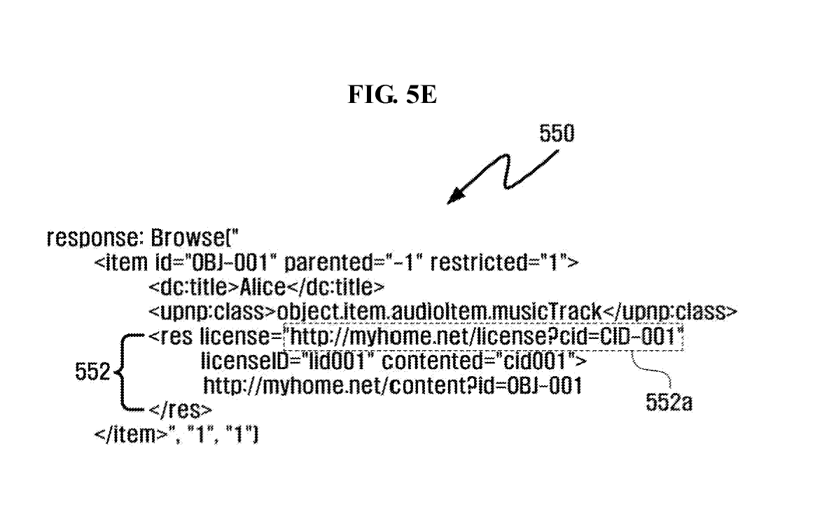

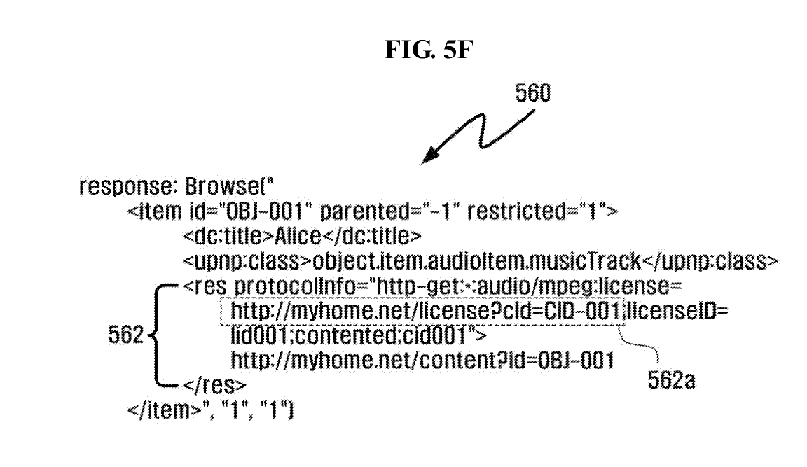

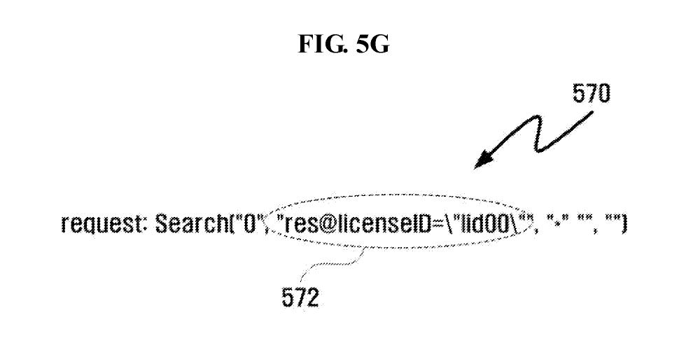

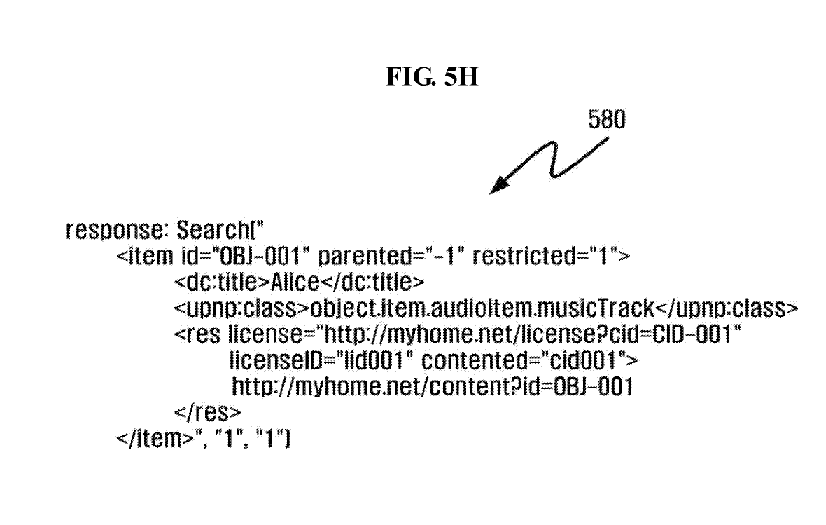

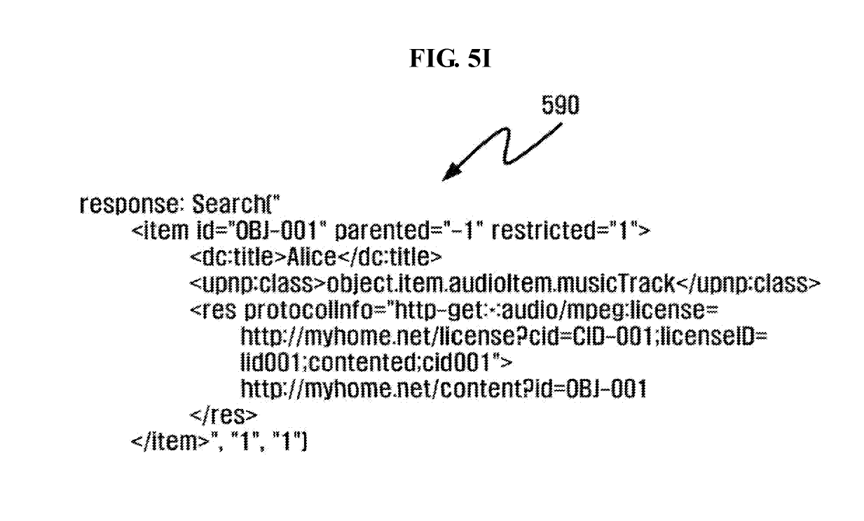

FIGS. 5A to 5C schematically show an exemplary embodiment of the request and response using the X_GetLicense action shown in Table 1.

FIG. 5A is a diagram showing a request 510 using an X_GetLicense action according to an exemplary embodiment of the present invention. The request 510 includes “CID-001” 512, “CONTENT” 514, and “OMA” 516 as the parameters of the arguments “ID”, “ID Type”, and “DRM Type” among the arguments shown in Table 1. Since the parameter of the argument “ID type” is “CONTENT” 514, the ID “CID-001” 512 denotes the contents ID. Further, since the parameter of the argument “DRM type” is “OMA” 516, an analysis can be made through the request 510 that the media renderer 130 expects an OMA DRM standard-based rights object. In FIG. 5A, a case where the ID type is the contents, but a request having a rights object ID as the ID type may be implemented, as described above.

FIG. 5B is a diagram showing a response 520 using an X_GetLicense action according to an exemplary embodiment of the present invention. The response 520 includes the rights object 522 as the argument “License” shown in Table 1. An EncryptedKey line 522a includes a contents encryption key. Although the rights object is not shown in FIG. 5B in detail, the rights object included in the response 520 can be expressed by an XML document.

FIG. 5C is a diagram showing a response 530 using an X_GetLicense action according to another exemplary embodiment of the present invention. The response 530 includes the URI 532 of the rights object. When the response 530 is received, the media renderer 130 accesses the URI “myhome.net/licence?cid=CID-001” to acquire the rights object.

According to an exemplary embodiment of the present invention, in order to allow the media renderer 130 and the media server 120 to share the rights object in the DRM domain, a UPnP CDS-based browse action may be used. This will be described with reference to FIGS. 5D and 5E.

FIG. 5D is a diagram showing a request 540 using a browse action according to an exemplary embodiment of the present invention. In the request 540 shown in FIG. 5D, a first parameter “OBJ-001” 542 denotes a UPnP CDS-based object ID. The media server 120 can allocate the UPnP CDS-based object ID to the rights object to be newly stored. If the media renderer 130 knows the object ID of the rights object, the rights object request message can be generated using a browse action shown in FIG. 5D.

FIG. 5E is a diagram showing an example of a response to the request 540 using the browse action shown in FIG. 5D. The response 550 shown in FIG. 5E can include a URI 552a of an object (that is, rights object) to be identified by an object ID 542 included in the request 540 of FIG. 5D as an attribute of a <res> property 522 in the UPnP CDS-based browse action. FIG. 5F is a diagram showing another example of a response 560 to the request 540 using the browse action shown in FIG. 5D. In the response 560 shown in FIG. 5F, a URI 562a of a rights object is included as the attribute of the <res> property 562.

The media renderer 130 acquires the URI of the rights object from the media server 120 through the rights object response message including the response 550 or 560 shown in FIG. 5E or 5F, and acquires the rights object using the corresponding URI.

According to an exemplary embodiment of the present invention, in FIG. 5E or FIG. 5F, a rights object may be included, instead of the URI. Here, the rights object may be expressed by an XML document. According to an exemplary embodiment of the present invention, in order to allow the media renderer 130 and the media server 120 to share the rights object in the DRM domain, a UPnP CDS-based search action may be used. FIG. 5G is a diagram showing a request 570 using a search action according to an exemplary embodiment of the present invention, and FIGS. 5H and 5I show examples of a response to the request 570. The request 570 shown in FIG. 5G includes information 572 for identifying the domain rights object, such that the media server 120 can search the domain rights object requested by the media renderer 130 through the corresponding information. The reply 580 and the reply 590 shown in FIGS. 5H and 5I, respectively, are similar to the replies 550 and 560 shown in FIGS. 5E and 5F, and thus the detailed descriptions thereof will be omitted.

According to an exemplary embodiment of the present invention, the media server 120 generates and manages a UPnP CDS-based object (hereinafter, referred to as “rights object representing object”) that corresponds to the rights object and represents the rights object. The rights object representing object is newly defined according to an exemplary embodiment of the present invention. The rights object representing object can include all UPnP CDS-based object characteristics, and the <res> property of the rights object representing object can represent the URI of the corresponding rights object. Further, a rights object representing object class can succeed to the attribute of an item class. For example, the rights object representing object class can be represented by “object.item.licenseItem.omaDrm”.

According to an exemplary embodiment of the present invention, the media server 120 can newly define a container object that manages the rights object. A part of res@protocolInfo property that represents Multipurpose Internet Mail Extensions (MIME) in the resource in the new container object can follow a rights object MIME type that is defined by the DRM standard for the rights object. Foe example, if the rights object is based on the OMA DRM, a part of the res@protocolInfo property can follow application/vnd.oma.drm.ro_xml.

As such, in a case where the additional rights object representing object corresponding to the rights object is managed, if the media renderer 130 requests for the rights object, the media server 120 can provide the rights object representing object corresponding to the requested rights object to the media renderer 130. Since the <res> property of the rights object representing object represents the URI of the rights object, the media renderer 130 accesses the corresponding URI to acquire the rights object.

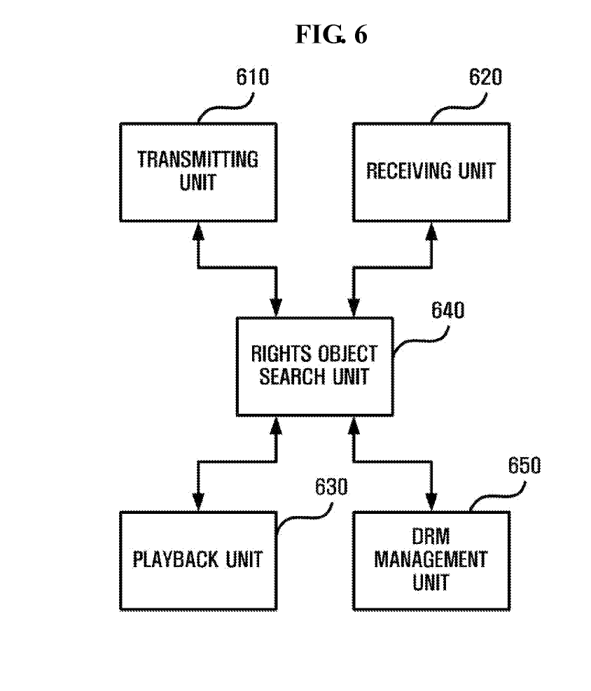

FIG. 6 is a block diagram showing a media renderer 130 according to an exemplary embodiment of the present invention. The media renderer 130 includes a transmitting unit 610, a receiving unit 620, a playback unit 630, a DRM management unit 640, and a rights object search unit 650.

The transmitting unit 610 transmits data, messages, and other kinds of information to other devices or networks, and the receiving unit 620 receives data, messages, and other kinds of information from other devices or networks. In FIG. 6, the transmitting unit 610 and the receiving unit 620 are provided separately from each other, but a single component having the functions of the transmitting unit 610 and the receiving unit 620 may be provided according to exemplary embodiments of the present invention. The transmitting unit 610 and the receiving unit 620 can use wireless communication protocols, such as Wireless LAN, Wireless PAN, and Bluetooth, or wired communication protocols, such as Power Line Communication (PLC), Institute of Electrical and Electronics Engineers 1394 (IEEE 1394), and Universal Serial Bus (USB). The transmitting unit 610 and the receiving unit 620 may use both the wired and wireless communication protocols.

The playback unit 630 plays back the contents object using the rights object. The playback unit 630 may be based on the digital media processing standard, such as Moving Picture Experts Group (MPEG), MPEG audio layer-3 (MP3), or Joint Photographic coding Experts Group (JPEG).

The DRM management unit 640 generates, processes, and analyzes the messages for the digital rights management, and controls the use of the rights object. For example, the DRM management unit 640 can control the DRM domain subscription process described with reference to FIG. 2, and when the playback unit 630 tries to play back the contents object using the rights object, can determine whether or not to permit the playback. The permission on the use of the rights object can be determined using the permission information and constraint information of the rights object. In addition, the DRM management unit 640 takes charge of the security in the DRM domain. According to an exemplary embodiment of the present invention, the DRM management unit 640 may include an encoder/decoder (not shown) and a secure storage unit (not shown).

The encoder/decoder performs decoding of the contents object using the contents encryption key of the rights object, and encoding and decoding for protecting the domain rights object in the DRM domain. The encoder/decoder can use at least one of public key cryptography, such as Diffie-Hellman, Rivest Shamir Adleman (RSA), ElGamal, or Elliptic Curve, and symetric key cryptography, such as Data Encryption Standard (DES) or Advanced Encryption Standard (AES).

The secure storage unit stores data to be secured, such as the rights object, the domain key, and a private key for the public key cryptography. The secure storage unit can be logically and physically protected from an access of an external device.

Returning to FIG. 6, the rights object search unit 650 acquires the rights object from the media server 120. The rights object search unit 650 generates and analyzes a message based on a UPnP AV protocol. For example, the rights object search unit 650 can perform the UPnP CDS-based actions shown in FIGS. 5A to 5I.

When the media renderer 130 is a UPnP AV compatible device, the media renderer 130 may further include a control unit (not shown) that processes a UPnP-based operation (for example, discovery or advertising) may be included. The control unit may be incorporated into the rights object search unit 650.

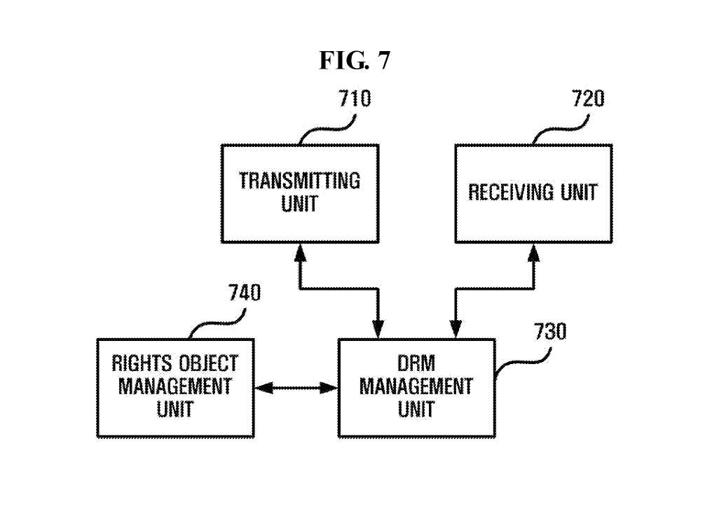

FIG. 7 is a block diagram showing a media server 120 according to an exemplary embodiment of the present invention. The media server 120 includes a transmitting unit 710, a receiving unit 720, a DRM management unit 730, and a rights object management unit 740.

The transmitting unit 710 and the receiving unit 720 are similar to the transmitting unit 610 and the receiving unit 620 of the media renderer 130 described with reference to FIG. 6, and thus the detailed descriptions thereof will be omitted.

The DRM management unit 730 controls generation, processing, and analysis of the messages for the digital rights management. For example, the DRM management unit 730 can control the DRM domain subscription process described with reference to FIG. 2. Further, the DRM management unit 730 can take charge of the security in the DRM domain. According to an exemplary embodiment of the present invention, the DRM management unit 730 may include an encoder/decoder (not shown) and a secure storage unit (not shown).

The encoder/decoder performs encoding and decoding for protecting the domain rights object in the DRM domain. The encoder/decoder can use at least one of public key cryptography, such as Diffie-Hellman, RSA, ElGamal, or Elliptic Curve, and symetric key cryptography, such as DES or AES.

The secure storage unit stores data to be secured, such as the rights object, the domain key, and the private key for the public key cryptography. The secure storage unit can be logically and physically protected from an access of an external device.

Returning to FIG. 7, the rights object management unit 740 provides the rights object with the media renderer 130. The rights object management unit 740 generates and analyzes the messages based on the UPnP AV protocol. For example, the rights object management unit 740 can process the UPnP CDS-based actions shown in FIGS. 5A to 5I. In addition, the rights object management unit 740 can perform UPnP CDS-based object management. For example, if a new rights object is stored, the rights object management unit 740 can give an object ID to the rights object, or can generate a rights object representing object corresponding to the rights object.

When the media server 120 is a UPnP AV compatible device, the media server 120 may further include a control unit (not shown) that processes a UPnP-based operation (for example, discovery or advertising). The control unit may be incorporated into the rights object management unit 740.

The operations among the components of the media renderer 130 and the media server 120 described with reference to FIGS. 6 and 7 can be understood in more detail with reference to the descriptions of FIG. 1 to FIG. 5C.

The individual components of the media renderer 130 and the media server 120 shown in FIGS. 6 and 7 can be implemented by a module. The term “module”, as used herein, denotes, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they are executed on one or more computers in a communication system. If the module is implemented by only software, each of the terminal 110 and the Web server 120 may further include a processor that can execute software.

Although the invention has been described in connection with the exemplary embodiments of the invention, it will be apparent to those skilled in the art that various modifications and changes may be made thereto without departing from the scope and spirit of the invention. Therefore, it should be understood that the above exemplary embodiments are not limitative, but illustrative in all aspects.

According to the above-described digital rights management method and apparatus of exemplary embodiments of the present invention, the rights object is shared between the devices, and thus the rights object can be efficiently used.

What is claimed is:

1. A digital rights management (DRM) method comprising:
transmitting a rights object request message;
receiving a rights object response message based on a Universal Plug and Play (UPnP) contents directory service; and
acquiring a rights object using the rights object response message.

2. The DRM method of claim 1, wherein the rights object response message includes the rights object or a uniform resource identifier (URI) of the rights object.

3. The DRM method of claim 1, wherein the rights object request message includes at least one of a contents identifier (ID) of contents corresponding to the rights object, a rights object ID of the rights object, and an object ID based on the UPnP contents directory service allocated to the rights object.

4. The DRM method of claim 1, wherein the rights object request message is generated using an action based on the UPnP contents directory service.

5. The DRM method of claim 4, wherein the action is a browse action or a search action.

6. The DRM method of claim 4, wherein the action includes at least one of an identifier (ID) argument representing a rights object ID or a contents ID, an ID type argument indicating which of the rights object ID and the contents ID the ID argument represents, and a DRM type argument for identifying a DRM standard of a requested rights object.

7. A digital rights management (DRM) method comprising:
receiving a rights object request message; and
transmitting a rights object response message based on a Universal Plug and Play (UPnP) contents directory service.

8. The DRM method of claim 7, wherein the rights object response message includes a rights object or a uniform resource identifier (URI) of the rights object.

9. The DRM method of claim 7, wherein the rights object response message is generated using an action based on the UPnP contents directory service.

10. The DRM method of claim 9, wherein the action is a browse action or a search action.

11. The DRM method of claim 9, wherein an attribute of a <res> property in the action represents a rights object or a uniform resource identifier (URI) of the rights object.

12. The DRM method of claim 7, wherein the rights object response message corresponds to a rights object and includes a rights object representing object having a uniform resource identifier (URI) of the rights object, and the rights object representing object is an object based on the UPnP contents directory service.

13. A digital rights management (DRM) apparatus comprising:
a transmitting unit which transmits a rights object request message to a media server of a DRM domain;
a receiving unit which receives a rights object response message based on a Universal Plug and Play (UPnP) contents directory service from the media server; and
a playback unit which plays back a contents object on a basis of a rights object acquired using the rights object response message.

14. The DRM apparatus of claim 13, wherein the rights object response message includes the rights object or a uniform resource identifier (URI) of the rights object.

15. The DRM apparatus of claim 13, wherein the rights object request message includes at least one of a contents identifier (ID) of contents corresponding to the rights object, a rights object ID of the rights object, and an object ID based on the UPnP contents directory service allocated to the rights object.

16. The DRM apparatus of claim 13, wherein the rights object request message is generated using an action based on based on the UPnP contents directory service.

17. The DRM apparatus of claim 16, wherein the action is a browse action or a search action.

18. The DRM apparatus of claim 16, wherein the action includes at least one of an identifier (ID) argument representing a rights object ID or a contents ID, an ID type argument indicating which of the rights object ID and the contents ID the ID argument represents, and a DRM type argument for identifying a DRM standard of a requested rights object.

19. A digital rights management (DRM) apparatus comprising:
a receiving unit which receives a rights object request message from a media renderer of a DRM domain; and
a transmitting unit which transmits a rights object response message based on a Universal Plug and Play (UPnP) contents directory service to the media renderer.

20. The DRM apparatus of claim 19, wherein the rights object response message includes a rights object or a uniform resource identifier (URI) of the rights object.

21. The DRM apparatus of claim 19, wherein the rights object response message is generated using an action based on the UPnP contents directory service.

22. The DRM apparatus of claim 21, wherein the action is a browse action or a search action.

23. The DRM apparatus of claim 21, wherein an attribute of a <res> property in the action represents a rights object or a uniform resource identifier (URI) of the rights object.

24. The DRM apparatus of claim 19, wherein the rights object response message corresponds to a rights object and comprises a rights object representing object having a uniform resource identifier (URI) of the rights object, and the rights object representing object is an object based on the UPnP contents directory service.

25. A digital rights management (DRM) method comprising:
if a media server exists in a DRM domain, acquiring a rights object from the media server; and
if the media server does not exist in the DRM domain, acquiring a rights object from a rights object issuing server,
wherein the acquiring of the rights object from the media server comprises:
transmitting a rights object request message to the media server;
receiving a rights object response message based on a Universal Plug and Play (UPnP) contents directory service from the media server; and
acquiring the rights object using the rights object response message.
